(19) United States
(12) Patent Application Publication
(10) Pub. No.: US 2009/0106831 A1
(43) Pub. Date: Apr. 23, 2009

(54) IPsec GRE TUNNEL IN SPLIT ASN-CSN SCENARIO

(76) Inventor: Yingzhe WU, San Marcos, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/253,105

(22) Filed: Oct. 16, 2008

Related U.S. Application Data
(60) Provisional application No. 60/981,090, filed on Oct. 18, 2007.
(60) Provisional application No. 60/984,701, filed on Nov. 1, 2007.

(51) Int. Cl. G06F 15/16; G06F 9/00

(52) U.S. Cl. 726/15

(57) ABSTRACT

An Internet Protocol Security (IPsec) protected Generic Routing Encapsulation (GRE) tunnel is established between the Access Service Network (ASN) and Connectivity Service Network (CSN) of a Simple IP network. A GRE layer is inserted between the user plane and the IP transport plane, and a GRE key is used to differentiate each user session. The IPsec protected GRE tunnel may be used to provide full Dynamic Host Configuration Protocol (DHCP) configuration support. It may also used to provide broadcast/multicast support, as well as non-IP traffic support. The GRE key may consist of a first half key and a second half key; the first half key may be allocated by a first node, and the second half key may be allocated by a second node.

### RELATED APPLICATIONS

This application claims benefit of priority under 35 U.S.C. § 119(e) to Provisional Application No. 60/981,090, entitled “IPsec GRE Tunnel in split ASN-CSN Scenario”, filed Oct. 18, 2007; and Provisional Application No. 60/984,701, entitled “IPsec GRE Tunnel in split ASN-CSN Scenario”, filed Nov. 1, 2007, each of which is hereby incorporated by reference in its entirety.

### BACKGROUND OF THE INVENTION

1. Field of the Invention

This invention relates to Internet Protocol (IP) networks, and more particularly, to methods and systems for establishing an Internet Protocol Security (IPsec) protected Generic Routing Encapsulation (GRE) tunnel in Simple IP networks.

2. Discussion of Related Technology

A wireless network, such as a WiMAX network based on IEEE802.16d/e standard, usually includes mobile stations and base stations. The mobile stations can be used while in motion or during halts at unspecified points, while the base stations provide connectivity, management, and control for the mobile stations. The wireless network may consist of an Access Service Network (ASN) and a Connectivity Service Network (CSN). An ASN is a set of network devices and protocols that provide radio access to mobile stations. A CSN is a set of network devices and protocols that provide IP connectivity services to mobile stations. More detailed discussion of various components in a WiMAX network can be found in WiMAX Forum Network Architecture (Stage 3: Detailed Protocols and Procedures), Jul. 11, 2007, Release 1.1.0, hereby incorporated by reference.

FIG. 1 illustrates a conventional wireless network model in accordance with a known WiMAX network architecture. As shown in FIG. 1, a mobile station (MS) 101, also referred to herein as a subscriber station (SS), is connected to ASN 111 provided by a Network Access Provider (NAP) 110 via a reference point or data path R1. As used herein, a reference point refers to a conceptual link that connects two groups of functional devises residing in different entities of a network, and is not necessarily a physical interface. ASN 111 is connected to CSN 121 provided by a Visited Network Service Provider (Visited NSP) 120 via a reference point R3, which functions as an interface between ASN 111 and CSN 121 to carry control information and IP packets. CSN 121 is connected to CSN 131 provided by a Home Network Service Provider (Home NSP) 130 via a reference point R5. CSN 121 and CSN 131 are also connected to an Application Service Provider (ASP) Network or the Internet.

As illustrated in FIG. 1, the WiMAX network includes ASN 111 that is separate from CSN 121. ASN 111 provides only radio access service, while CSN 121 provides only connectivity service. The IP address of the MS 101, which has location significance, can only be assigned from a CSN domain, either visited CSN 121 or home CSN 131. In order to send and receive packets targeted for MS to where the MS is really located (i.e., ASN 111), a tunnel (R3) needs to exist between ASN 111 and CSN 121. This tunnel can be established according to, for example, either Mobile IP protocol (MIP) or Proxy Mobile IP protocol (PMIP).

The Mobile IP protocol was first introduced by the Internet Engineering Task Force (IETF). In a Mobile IP environment, the R3 data path establishes a MIP session, which enables MS global roaming without changing its IP address. The MS with MIP capability can roam into different networks without losing its original IP address which is assigned when it registers with the network for the first time. However, many MS's don't have MIP capability. In order to provide those MS's with the same mobility performance as the MS's with MIP capability, a Proxy MIP protocol (PMIP) has been developed that enables a network entity called a PMIP client to conduct Mobile IP operations on behalf of the MS.

To provide MIP or PMIP service, network entities such as Foreign Agent (FA), Home Agent (HA), Mobile Access Gateway (MAG) and Local Mobility Anchor (LMA) need to be installed in both ASN and CSN networks. These entities are expensive and have complicated state machines. There is a great interest from Service Providers to set up networks without these entities during initial network deployment. One type of such a network is a Simple IP network, which operates in accordance with the Simple IP protocol. In a Simple IP network, a mobile station obtains a new IP address (and loses its existing connections) every time it changes its anchor point where the IP address comes from. One perceived realization of a Simple IP network is to co-locate an ASN and a CSN together. If the ASN and CSN are located together, IP addresses can be assigned by simple DHCP relay using DHCP server method, as specified by RFC2131 and RFC2132. RFCs are formal Requests for Comments documents of the Internet Engineering Task Force (IETF), publicly available, for example, at http://www.ietf.org/rfc.html. In a split ASN-CSN architecture, however, a protocol is still needed to establish a tunnel between the ASN and CSN because IP addresses need to be anchored at the CSN. One possible implementation is to pre-configure this tunnel between the ASN and CSN, but this solution does not scale well. Another possible implementation is to establish a tunnel by setting up a private virtual network (VPN) in accordance with the Internet Protocol Security (IPsec), referred herein as “Client IPsec VPN.”

Internet Protocol Security (IPsec) is a protocol that provides security services at the IP layer. IPsec can be used to protect one or more paths between a pair of hosts, between a pair of secure gateways, or between a security gateway and a host. An example of an IPSec protocol is specified in RFC4301 and RFC4306.

The IPsec architecture uses the concept of a security association (SA) as the basis for building security functions into IP. An SA is simply a bundle of algorithms and parameters (such as keys) used to encrypt and authenticate a particular data flow in a particular direction. The protection offered by an SA is based on requirements defined by a Security Policy Database (SPD). The protection offered by the SA can also be fine-tuned by a set of selectors. Some of the commonly used selectors are Remote IP Address(es), Local IP Address(es), Next Layer Protocol (referred herein simply as the “protocol”), Local Port, and Remote Port. Specific IPsec implementation may choose to implement IP addresses only, IP addresses and protocol, or IP addresses, protocol and ports. Implementation of selectors without ports is coarse. If ports are implemented, they are negotiated with range, i.e., from “start port” to “end port” for both Local Port and Remote Port.

The IPSec protocol may be implemented in either tunnel mode or transport mode. In tunnel mode, the entire IP packet (data plus the message headers) is encrypted and/or authenticated. Tunnel mode can be used for network-to-network, host-to-network, and host-to-host communications over the Internet. In transport mode, only the payload (the data you transfer) of the IP packet is encrypted and/or authenticated. Transport mode is used for host-to-host communications.

Client IPsec VPN implementation is described by RFC3456. FIG. 2 illustrates a conventional Client IPsec VPN implementation. As shown in FIG. 2, a mobile station (MS) 201, often referred to as road warrior, obtains a local IP address in visited domain, and then acts as a host to establish an IPsec tunnel to its home Security Gateway (SG) 231. MS 201 is assigned a home internal IP address by tunneling DHCP message within the IPsec tunnel to the SG 231 and is able to access all resources in its home network 230. Such implementation is well deployed and understood. The IPsec tunnel operates in tunnel mode in host to gateway configuration. It supports full DHCP configurability, and provides confidentiality and integrity. This implementation can also be enhanced to support mobility by using MOBIKE (RFC4555).

If the MS is not IPsec capable, the ASN Gateway (ASN-GW) can function as an endpoint to establish a network based IPsec tunnel. FIG. 3 illustrates an exemplary network based IPsec VPN implementation in a wireless network. In this configuration, the IPsec tunnel is established between ASN-GW 311 and home SG 331. This is very similar to conventional network based IPsec VPN, but has a few significant differences.

In a conventional network based IPsec VPN, both ends are stationary networks with stationary hosts, and each host is assigned an IP address in its local subnet. On the other hand, in FIG. 3, one end of the IPsec tunnel (ASN-GW 311) has roaming MS's 301 come and go, and each MS uses the IP address from its home network as the tunnel inner address in IPsec processing.

Since the IPsec tunnel between ASN-GW 311 and home SG 331 is now shared among many MS's 301 as opposed to a dedicated tunnel in a conventional client IPsec, there are many problems that need to be resolved in this network based IPsec VPN implementation in a wireless network. Specifically, the IPsec tunnel in this implementation is not able to route and differentiate concurrent DHCP sessions, because all DHCP broadcast messages have the same addresses: 0.0.0.0 and 255.255.255.255. It is also not able to route and encrypt multicast traffic because the Security Policy Database (SPD) entry cannot provide ANY to ANY selector as in a conventional client IPsec. Multicast routing in general will require Group Security Association (GSA) and multicast capable IPsec implementation. Furthermore, the IPsec tunnel in this implementation is not able to route and encrypt private IPv4 addresses because there are duplicate private IPv4 addresses in the same ASN.

Therefore, there is a need for improved methods and systems for establishing an IPsec tunnel for Simple IP networks in split ASN-CSN realization, in accordance with various embodiments of the invention.

### SUMMARY OF THE INVENTION

A wireless network, such as a WiMAX network, usually includes an Access Service Network (ASN) for providing radio access to mobile stations, and a Connectivity Service Network (CSN) for providing IP connectivity service to mobile stations. In a Simple IP network that does not support either the MIP or PMIP protocol, a tunnel needs to be established between the ASN and CSN to transmit control information and IP packets.

Embodiments of the present invention are directed to methods and systems for establishing an Internet Protocol Security (IPsec) protected Generic Routing Encapsulation (GRE) tunnel in Simple IP networks. In one embodiment, a GRE layer is inserted between the user plane and the IP transport plane, and a GRE key is used to differentiate each user session. The IPsec protected GRE tunnel may be used to provide full DHCP configuration support. It may also used to provide broadcast/multicast support, as well as non-IP traffic support.

In a further embodiment, a method of asymmetric GRE key allocation is provided. The GRE key may consist of a first half key and a second half key; the first half key may be allocated by a first node, and the second half key may be allocated by a second node.

### BRIEF DESCRIPTION OF THE DRAWINGS

FIG. 1 illustrates a conventional wireless network model in accordance with a known WiMAX network architecture.

FIG. 2 illustrates a conventional client IPsec VPN implementation.

FIG. 3 illustrates a conventional network based IPsec VPN implementation in a wireless network.

FIG. 4 illustrates an exemplary IPsec protected GRE tunnel in accordance with one embodiment of the present invention.

FIG. 5 is a flow chart for establishing an exemplary IPsec protected GRE tunnel in accordance with one embodiment of the present invention.

FIG. 6 is a flow chart for an exemplary method of allocating a GRE key for IPsec processing in accordance with one embodiment of the present invention.

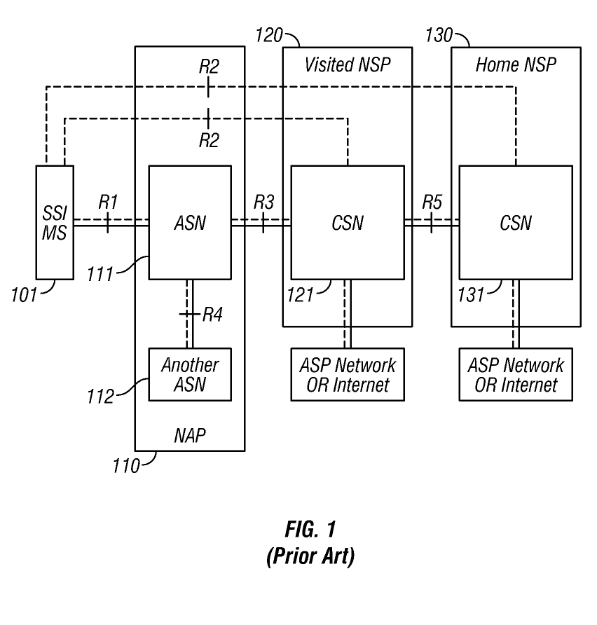

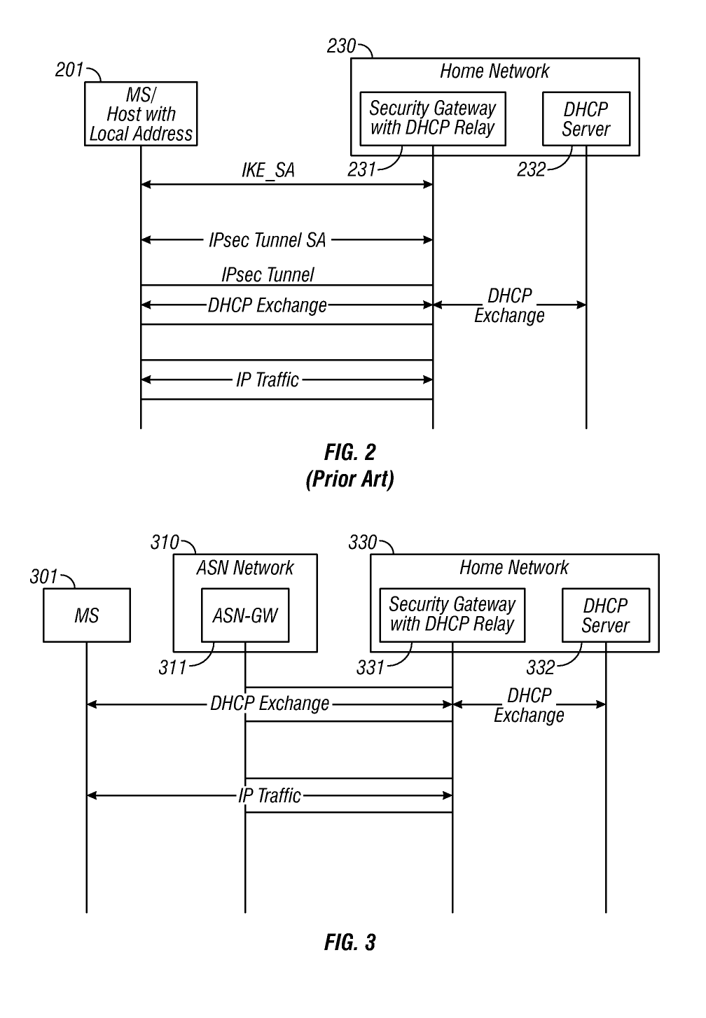

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

Although embodiments of the present invention are described herein in terms of a WiMAX network, it should be understood that the present invention is not limited to this application, but is generally applicable to any wireless network.

Embodiments of the present invention are directed to methods and systems for establishing an IPsec protected Generic Routing Encapsulation (GRE) tunnel in Simple IP networks.

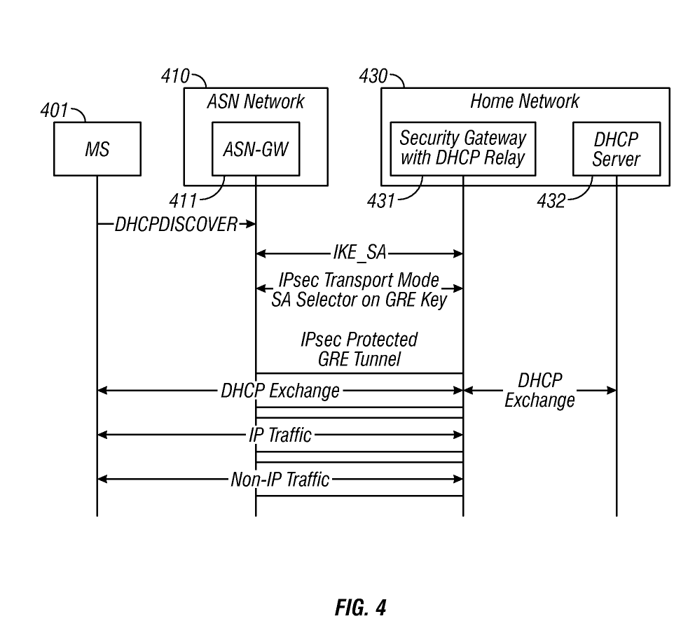

FIG. 4 illustrates an exemplary IPsec protected GRE tunnel in accordance with one embodiment of the present invention. In this embodiment, a GRE layer is inserted between the user plane and the IP transport plane, and an IPsec protected GRE tunnel is established between ASN-GW 411 and home SG 431. To differentiate each user session, the GRE layer provides a key field for de-multiplexing purpose. This will allow broadcast/multicast packets, such as Router Solicitation, Agent Solicitation and DHCP configuration messages, as well as regular multicast user traffic, to be sent from and received by different MS's. An additional benefit of the GRE layer is that it will allow tunneling of other types of packets, such as Ethernet or PPP frames, from the ASN-GW 411 to home SG 431, as long as the type of traffic can be agreed upon or is known a priori before the GRE tunnel is established.

The GRE protocol is specified in RFC2890. A GRE packet is formed by adding a GRE header to the payload (the data that needs to be encapsulated and routed). The resulting GRE packet can be further processed and routed throughout the system with security. The GRE header may include a key field containing a four octet number which is inserted by the encapsulator. The key may be used by the receiver to authenticate the source of the packet.

The RFC2890 specification itself doesn't specify how the GRE key is allocated. In addition, a separate protocol such as MIP is generally needed to exchange the keys allocated by both ends. The GRE key assignment can be symmetric or asymmetric, but due to the limitation of the current IPsec implementation, the receiver side IPsec may not be able to negotiate a different GRE key in the other direction (asymmetric key assignment). Therefore, in one embodiment of the invention, only symmetric GRE key assignment (assigned by the initiator side) is used, and each initiator side, such as ASN-GW, may allocate GRE key in its own space. When the IPsec GRE tunnel is established between many ASN-GWs to many home SGs, the home SGs may use the source address (ASN-GW address) in addition to the GRE key field to identify a particular user session.

Because of the insertion of GRE layer between user plane and transport plane, IPsec tunnel mode can no longer be employed. IPsec in transport mode has to be used, with IP address selectors set to both endpoints of the security gateways, GRE as the “protocol” field and GRE key as the “port” fields. Using the GRE key as the “port” field is new to IPsec specifications (RFC4301, RFC4306). Thus, IPsec implementation may need to be extended to support using GRE as the “protocol” field and the 32 bit GRE key in the “port” selector fields. Each traffic selector port field is only 16 bit wide, so the 32 bit GRE key field may need to occupy both the “start port” and “end port” fields. The remote traffic selectors may be coded the same way in the case of symmetric GRE key allocation.

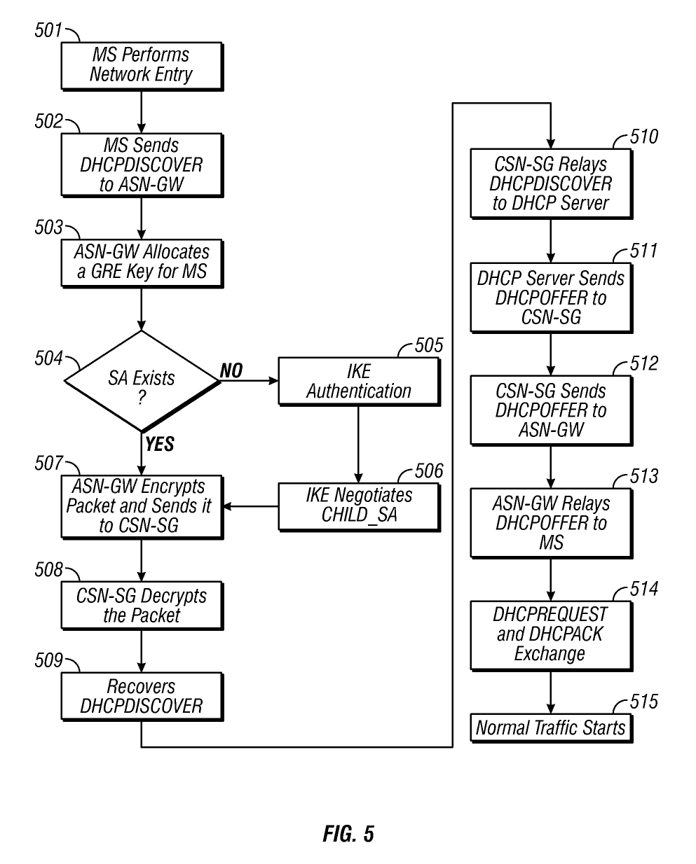

FIG. 5 is a flow chart for establishing an exemplary IPsec protected GRE tunnel in accordance with one embodiment of the present invention.

In step 501, MS performs network entry. During the authentication procedure, Security Gateway address is exchanged on both ends at ASN and CSN. Both ASN and CSN add a SPD entry to allow IPsec ESP transport mode protection. The selectors are set as following: “source address”=ASN-GW, “destination address”=CSN SG, “protocol”=GRE, “port”=ANY, “PFP”=1.

In step 502, MS sends DHCPDISCOVER packet to the ASN-GW. Before proceeding further, ASN-GW verifies that the client identifier in the DHCPDISCOVER message is the same as the Mobile Node's Network Access Identifier (MN_NAI) used during the network entry phase.

In step 503, ANS-GW allocates a GRE key for the MS, encapsulates the packet, finds out the destination address of the CSN SG, and sends the packet to local IPsec for processing.

In step 504, the local IPsec on ASN-GW finds the SPD entry for the GRE packet, and determines whether a corresponding SA exists. If no corresponding SA exists for the match, the IPsec will trigger an Internet Key Exchange (IKE) process to obtain an SA according to steps 505 and 506.

In step 505, the IKE first exchanges message with remote CSN SG to authenticate. The authentication is carried out based on node credential.

In step 506, during the authentication phase, an SA (CHILD_SA) is negotiated in IPsec ESP transport mode. The selectors are set as following: “protocol”=GRE, “port”=GRE key. CHILD_SA will be established successfully because both ends have the corresponding SPD entry.

In step 507, with the right SA in place, the ASN-GW sends out the GRE packet to the CSN SG with the negotiated SA.

In step 508, CSN SG decrypts the packet, verifies the traffic selector, and handovers the packet to GRE function for processing.

In step 509, the GRE function removes the GRE header, and recovers the DHCPDISCOVER packet.

In step 510, the CSN SG functions as a DHCP relay, appends a relay agent option (subscriber ID=MN_NAI) to the message, and relays it to the DHCP server.

In step 511, the DHCP server allocates an IP address for the MS, and sends DHCPOFFER message to the CSN SG. The CSN SG relays the message onto the corresponding GRE tunnel.

The reverse direction works in a similar way to the forward direction. In step 512, the CSN SG finds the right SA to protect this GRE packet and sends it to ASN-GW.

In step 513, after ASN-GW decrypts the packets and verifies the traffic selector, it relays the packet to the MS.

In step 514, one more round of DHCP exchange (DHCPREQUEST and DHCPACK) takes place, but this time the SA is already in place, so steps 505 and 506 are not repeated.

After the IP address has been configured successfully, normal traffic starts in step 515. CSN SG also adds a route entry in its local routing table for all MS traffic through the correct GRE tunnel. This will make sure that all packets destined for the MS will be routed correctly.

In accordance with this embodiment of the invention, the GRE key is allocated by the ASN-GW in its own space, and the same GRE key is used by both the ASN-GW and CSN-SG (symmetric GRE key assignment). The CSN-SG may use the source address (ASN-GW address) in addition to the GRE key field to identify a particular user session.

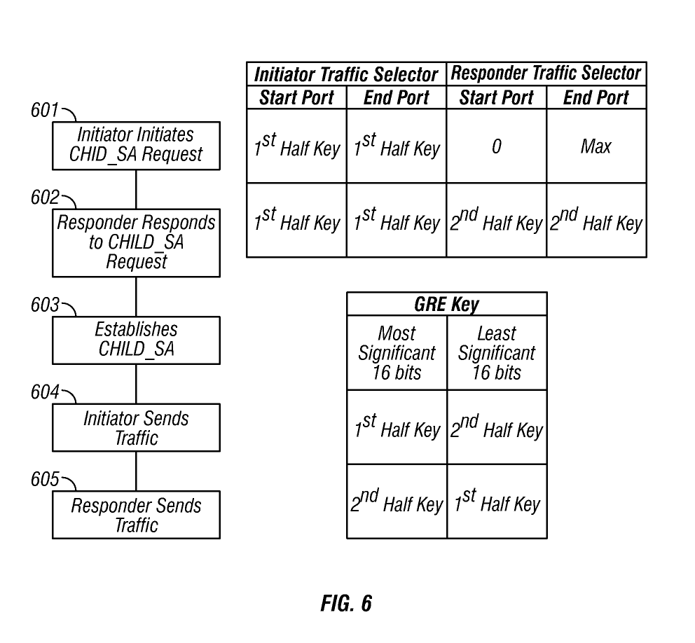

FIG. 6 is a flow chart for an exemplary method of allocating a GRE key for IPsec processing in accordance with another embodiment the present invention. In this embodiment, a different method of how to fit the 32 bit GRE key into the 16 bit traffic selector “port” field is described herein. This embodiment of the invention is suitable for asymmetric GRE key allocation, but based on the assumption that the IKE responder side has an interaction between IKE/IPsec subsystem and GRE subsystem, such that a receiver side GRE key can be dynamically allocated during the CHILD_SA traffic selector negotiation. Additionally, this embodiment of the invention describes how the GRE key field is to be used when working with IPsec.

As discussed earlier and specified in RFC2890, the GRE header contains a 32 bit GRE key field. When used in an IPsec environment, the selector “port” fields may be used for the GRE key. As illustrated in FIG. 6, in step 601, the CHILD_SA exchange initiator allocates a 16 bit GRE half key to be included in both “start port” and “end port” in initiator traffic selector fields. This is a trivial range for single value. The responder traffic selector fields will be set to ANY, i.e., “start port”=0 and “end port”=max. In step 602, upon receiving the CHILD_SA negotiation request, the exchange responder allocates its own 16 bit GRE half key to be included in both “start port” and “end port” in responder traffic selector fields. This is also a trivial range for single value. After this negotiation, in step 603, the CHILD_SA is established and traffic can be exchanged. In step 604, when sending traffic, the initiator will include its 16 bit GRE half key in the most significant bits of the 32 bit key field in GRE header and the responder GRE half key in the least significant bits of the 32 bit key field. In step 605, when sending traffic in the other direction, the locations of the keys are swapped, with responder GRE half key in the most significant position and the initiator GRE half key in the least significant position.

The method of using GRE key in accordance with this embodiment of the invention may be similar to TCP/UDP port usage, i.e., both source and destination ports identify a unique connection between two IP endpoints, with port locations swapped in forward and reverse directions. In accordance with this embodiment of the invention described herein, both source and destination GRE half keys identify a unique GRE connection between two IP endpoints and the GRE key field can be protected by IPsec in the same way as TCP/UDP ports can be protected by IPsec. However, this embodiment of the invention does not mandate how the 16 bit GRE half key is allocated within the node. The 16 bit GRE half key can be unique within the node irrespective of what destination it is communicating with, or the 16 bit GRE half key can be unique among all communications with a particular destination, or the 16 bit GRE half key can be unique among all communications with a particular destination and the GRE half key of the destination. As long as the allocation of key can unambiguously identify a unique GRE connection among all possible communications with other nodes, any allocation method will work. To differentiate this version of the GRE from earlier versions, this version of GRE can be set to 2, such that when GRE is protected by IPsec, the “port” selectors can be used to identify a particular GRE connection with unique GRE key.

In another embodiment of the invention, an IPsec protected GRE tunnel can be setup by the network to tunnel all types of user traffic between the MS and the CSN. It would allow IP broadcast/multicast traffics, Ethernet/PPP frames to be tunneled between the MS and the CSN. Additionally, it would also allow full and centralized DHCP support at the CSN, and simple configuration at the ASN.

The embodiments of the invention may also provide one or more of the following advantages: (1) Using GRE encapsulation to provide broadcast/multicast support, as well as non-IP traffic support between ASN and CSN; (2) Providing support for IP host configuration using both DHCP relay and DHCP server at CSN, without added functionality such as DHCP relay or DHCP proxy at ASN; and (3) Using IPsec ESP transport mode, as well as dynamic SA negotiation for the GRE tunnel establishment, without a separate signaling exchange protocol, such as MIP.

While various embodiments of the present invention have been described above, it should be understood that they have been presented by way of example only, and not of limitation. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for Internet protocol security (IPsec) packet processing in a wireless network, the wireless network including an Access Service Network (“ASN”) for providing radio access to a mobile station, and a Connectivity Service Network (“CSN”) for providing IP connectivity services to the mobile station, the method comprising:
receiving a packet from the mobile station by an ASN Gateway (“ASN-GW”);
allocating a Generic Routing Encapsulation (GRE) key associated with the mobile station and encapsulating the packet with a GRE header containing the GRE key; and
performing IPsec processing for the packet in a transport mode wherein a port selector is based upon the GRE key.

2. The method of claim 1, wherein the GRE key occupies both a start port filed and an end port field of the port selector.

3. The method of claim 1, wherein the GRE key uniquely identifies a communication session between the mobile station and the ASN.

4. The method of claim 1, wherein the GRE key assignment is symmetric.

5. The method of claim 1, wherein the GRE key assignment is asymmetric.

6. The method of claim 1, further comprising sending the packet to a CSN Security Gateway (“CSN-SG”).

7. The method of claim 6, further comprising relaying the packet to a Dynamic Host Configuration Protocol (DHCP) server;

8. The method of claim 7, further comprising allocating an IP address for the mobile station.

9. The method of claim 8, wherein the mobile station is always allocated the same IP address.

10. The method of claim 1, further comprising negotiating a Security Association (“SA”) from a CSN Security Gateway (“CSN-SG”).

11. The method of claim 1, further comprising establishing a GRE tunnel between the ASN Gateway (“ASN-GW”) and a CSN Security Gateway (“CSN-SG”).

12. The method of claim 11, wherein the GRE tunnel provides support for DHCP configuration.

13. The method of claim 11, wherein the GRE tunnel provides support for IP broadcast or IP multicast.

14. The method of claim 11, wherein the GRE tunnel is used for transmitting non-IP traffic.

15. An apparatus for providing radio access to a mobile station in a wireless network, the apparatus comprising:
means for receiving a packet from the mobile station;
means for allocating a Generic Routing Encapsulation (GRE) key associated with the mobile station and encapsulating the packet with a GRE header containing the GRE key; and
means for performing Internet Protocol Security (IPsec) processing for the packet in transport mode wherein a port selector is based upon the GRE key.

16. The method of claim 15, wherein the GRE key occupies both a start port filed and an end port field of the port selector.

17. The apparatus of claim 15, wherein the apparatus is an ASN Gateway (“ASN-GW”).

18. The apparatus of claim 17, further comprising means for sending the packet to a CSN Security Gateway (“CSN-SG”);

19. The apparatus of claim 18, further comprising means for negotiating a Security Association (“SA”) from the CSN-SG.

20. The apparatus of claim 18, further comprising means for establishing a GRE tunnel between the ACS-GW and the CSN-SG.

21. The apparatus of claim 20, wherein the GRE tunnel provides support for Dynamic Host Configuration Protocol (DHCP) configuration.

22. The apparatus of claim 20, wherein the GRE tunnel provides support for IP broadcast or IP multicast.

23. The apparatus of claim 20, wherein the GRE tunnel is used for transmitting non-IP traffic.

24. A method for Internet protocol security (IPsec) packet processing in a wireless network, the method comprising:
allocating a first Generic Routing Encapsulation (GRE) half key associated with a first node;
allocating a second GRE half key associated with a second node;
encapsulating a packet with a GRE header containing a GRE key, the GRE key is based upon both the first GRE half key and the second GRE half key; and
performing IPsec processing for the packet in transport mode wherein a first port selector is based upon the first GRE half key, and a second port selector is based upon the second GRE half key.

25. The method of claim 24, wherein the GRE key uniquely identifies a communication session between the first node and the second node.

26. The method of claim 24, wherein the first GRE half key is allocated by the first node, and the second GRE half key is allocated by the second node.

27. The method of claim 24, wherein the first GRE half key uniquely identifies a communication session with the first node.

28. The method of claim 24, wherein the first GRE half key uniquely identifies a communication session with the second node.

29. The method of claim 24, wherein the first node includes the first GRE half key in the most significant bits of the GRE key, and the second GRE half key in the least significant bits of the GRE key in sending data to the second node.

30. The method of claim 24, wherein the second nodes includes the second GRE half key in the most significant bits of the GRE key, and the first GRE half key in the least significant bits of the GRE key in sending data to the first node.

31. The method of claim 24, further comprising establishing a GRE tunnel between the first node and the second node.

32. The method of claim 24, further comprising negotiating a security association (SA) with the second node.

33. The method of claim 32, wherein the second GRE half key is dynamically allocated during the SA negotiation with the second node.

34. The method of claim 24, wherein the first node is an Access Service Network Gateway (“ASN-GW”) in a Simple IP network, and the second node is a Connectivity Service Network Security Gateway (“CSN-SG”) in the Simple IP network.

35. The method of claim 34, further comprising establishing a GRE tunnel between the ACS-GW and the CSN-SG.

36. The method of claim 35, wherein the GRE tunnel provides support for Dynamic Host Configuration Protocol (DHCP) configuration.

37. The method of claim 35, wherein the GRE tunnel provides support for IP broadcast or IP multicast.

38. The method of claim 35, wherein the GRE tunnel is used for transmitting non-IP traffic.

39. A method for Internet protocol security (IPsec) packet processing in a wireless network, the wireless network including an Access Service Network (“ASN”) for providing radio access to a mobile station, and a Connectivity Service Network (“CSN”) for providing IP connectivity services to the mobile station, the method comprising:
receiving a packet from the mobile station by an ASN Gateway (“ASN-GW”);
allocating a first Generic Routing Encapsulation (GRE) half key associated with the mobile station;
negotiating a Security Association (“SA”) from a CSN Security Gateway (“CSN-SG”);
allocating a second GRE half key associated with the CSN-SG;
encapsulating the packet with a GRE header containing a GRE key, the GRE key is based upon both the first GRE half key and the second GRE half key; and
performing IPsec processing for the packet in transport mode wherein a first port selector is based upon the first GRE half key, and a second port selector is based upon the second GRE half key.

40. The method of claim 39, wherein the GRE key uniquely identifies a communication session between the mobile station and the ASN-GW.

41. The method of claim 39, wherein the first GRE half key is allocated by the ASN-GW, and the second GRE half key is allocated by the CSN-SG.

42. The method of claim 39, wherein the first GRE half key uniquely identifies a communication session with the ASN-GW.

43. The method of claim 39, wherein the first GRE half key uniquely identifies a communication session with the CSN-SG.

44. The method of claim 39, wherein the ASN-GW includes the first GRE half key in the most significant bits of the GRE key, and the second GRE half key in the least significant bits of the GRE key in sending data to the CSN-SG.

45. The method of claim 39, wherein the CSN-SG includes the second GRE half key in the most significant bits of the GRE key, and the first GRE half key in the least significant bits of the GRE key in sending data to the ASN-GW.

46. The method of claim 39, further comprising receiving the packet by the CSN-SG.

47. The method of claim 46, further comprising relaying the packet to a Dynamic Host Configuration Protocol (DHCP) server;

48. The method of claim 47, further comprising allocating an IP address for the mobile station.

49. The method of claim 48, wherein the mobile station is always allocated the same IP address.

50. The method of claim 39, wherein the second GRE half key is dynamically allocated during the SA negotiation with ASN-GW.

51. The method of claim 39, further comprising establishing a GRE tunnel between the ACS-GW and the CSN-SG.

52. The method of claim 39, wherein the GRE tunnel provides support for DHCP configuration.

53. The method of claim 39, wherein the GRE tunnel provides support for IP broadcast or IP multicast.

54. The method of claim 39, wherein the GRE tunnel is used for transmitting non-IP traffic.
